(19) United States
(12) Patent Application Publication
(10) Pub. No.: US 2006/0056680 A1
(43) Pub. Date: Mar. 16, 2006

(54) 3D volume construction from DICOM data

(76) Inventors: Sandy Stutsman, Providence, RI (US); Joshua Napoli, Arlington, MA (US); Won-Suk Chun, Cambridge, MA (US)

Correspondence Address: CANTOR COLBURN, LLP, 55 GRIFFIN ROAD SOUTH, BLOOMFIELD, CT, 06002, US

(21) Appl. No.: 10/939,807

(22) Filed: Sep. 13, 2004

(51) Int. Cl. G06K 9/00

(52) U.S. Cl. 382/154

(57) ABSTRACT

Systems and methods for constructing a 3D volume from digital imaging and communications in medicine (DICOM) data are provided. This 3D volume is part of a volume rendering pipeline. The 3D volume is accessible by volume rendering software for display on a 3D display device. A lookup table is used to adjust intensity values of voxels in the 3D volume.

### BACKGROUND

The present invention relates generally to image processing and, more particularly, to systems and methods for three-dimensional (3D) volume construction from digital imaging and communications in medicine (DICOM) data.

DICOM is the industry standard for transmission of medical images and other information. DICOM supports a wide range of medical images, including computed tomography (CAT/CT) and magnetic resonance (MRI/MR) images and medical images in the fields of radiology, cardiology, pathology, dentistry, and other fields. DICOM is currently the most common standard for receiving scanned images from a hospital. The DICOM standard provides for a directory file, which holds related DICOM files and organizes them by patient, study, and series.

FIG. 1 shows a typical DICOM file in the prior art. This file includes some fields in a DICOM header 100 followed by image data 102. The header 100 stores information about the patient's name, the type of scan, image dimensions and other information. The image data 102 in this example is MR image data. The image data 102 may contain information in three dimensions, but often, there is only a slice in each file. A slice is a 2D image that may be considered one slice through a 3D volume.

The DICOM standard provides for a variety of methods of representing 3D data, some of which lack information needed to construct 3D images. For example, the distance between slices of image data may be represented by a slice location field, a slice thickness field, or not at all. Images gathered under a series heading in a DICOM directory may or may not represent a 3D image. Window width and center fields specify a range and intensity of pixels may or may be included in representations. There is a need for a way to generate 3D images using the various DICOM representations, even when information is missing.

FIGS. 2-5 show various 2D displays of 3D DICOM data in the prior art. FIG. 2 shows a common way medical images, such as MR images are displayed on 2D devices, such as a conventional computer video display. The images are displayed as a list of thumbnails, one thumbnail for each slice of a volume. The thumbnails are selectable and displayable in a larger window. Producing 3D volumetric representations of DICOM data on a conventional 2D screen requires complex volumetric image processing. Such processing is performed by software packages, such as the Volumetric Tool Kit (VTK) from Kitware, Inc. that transforms DICOM data into representations suitable for 2D displays. FIGS. 3 and 4 show another typical way medical images are displayed in 2D—as views. Views along axial, sagital, and coronal planes are displayed separately (FIG. 3) or in one window as intersecting planes (FIG. 4). In FIG. 4, DICOM image slices 400 are processed by volumetric slicing software 402 and functions 404, 406, 408 produce axial (A), coronal (C), and sagital (S) slices for the display 410. FIG. 5 shows another way medical images are displayed in 2D—as surfaces. Software packages 500, such as Mercury Computer's AMIRA extract surfaces from DICOM data and perform segmentation, among other things, to create polygonal representations for output to 2D displays 502.

2D displays still require the viewer to attempt to visualize the 3D volume. There is no “z dimension” or depth that could be seen by rotating or walking around a 3D image. In addition, the processing for these 2D displays is complex, time consuming, and costly. There is a need for a way to more simply, intuitively, and completely display the DICOM data. A 3D image of the medical information on a 3D display device would lead to better diagnoses and treatments for patients. Accordingly, it would be desirable to have systems and methods for constructing 3D volumes from DICOM data that are suitable for a 3D display device, among other aspects.

However, no conventional software packages produce DICOM output suitable for 3D display devices. 3D display devices require direct access to the volumetric image data without the mediation of complex software. For efficient rendering of DICOM data on a 3D display, the image data needs to be formatted into a rectilinear buffer that is part of a 3D display rendering pipeline.

### SUMMARY

The foregoing discussed drawbacks and deficiencies of the prior art are overcome or alleviated by systems and methods for 3D volume construction from DICOM data.

In an exemplary embodiment, a system for constructing 3D volumes from digital imaging and communications in medicine (DICOM) data includes a loader and a constructor. The loader loads a DICOM data set into a memory of a computing device. The memory is part of a 3D volume rendering pipeline. The constructor constructs a 3D volume in the memory from the DICOM data set. The 3D volume is in a format for rendering at least a portion of the 3D volume to a 3D display device.

In another exemplary embodiment, a method is for constructing 3D volumes from DICOM data. Image data is found in a DICOM data set on a storage device. The image data includes a plurality of slices. The slices are formed into a 3D volume in a memory of a computing device. The 3D volume is provided. In yet another exemplary embodiment, a storage medium includes machine-readable instructions for causing a computing machine to perform a method for constructing 3D volumes from DICOM data. Pixels in a DICOM data set are converted to voxels. An intensity value range is determined for each voxel. The intensity value ranges are held in a lookup table. A 3D volume is formed in a memory buffer in a volume rendering pipeline. The 3D volume has voxels. The lookup table is applied to the 3D volume and the 3D volume is provided.

### BRIEF DESCRIPTION OF THE DRAWINGS

Referring to the exemplary drawings wherein like elements are numbered alike in the several figures:

FIG. 1 shows a typical DICOM file in the prior art;

FIGS. 2, 3, 4, and 5 show various 2D displays of 3D DICOM data in the prior art;

FIG. 6 is a block diagram of a system for 3D volume construction from DICOM data, in accordance with an embodiment of the invention; and

FIG. 7 is an exemplary user interface including a picture of a 3D display device.

### DETAILED DESCRIPTION

Disclosed herein are systems and methods for 3D volume construction from DICOM data. The system and method embodiments described hereinafter thus allow for display on a 3D display device.

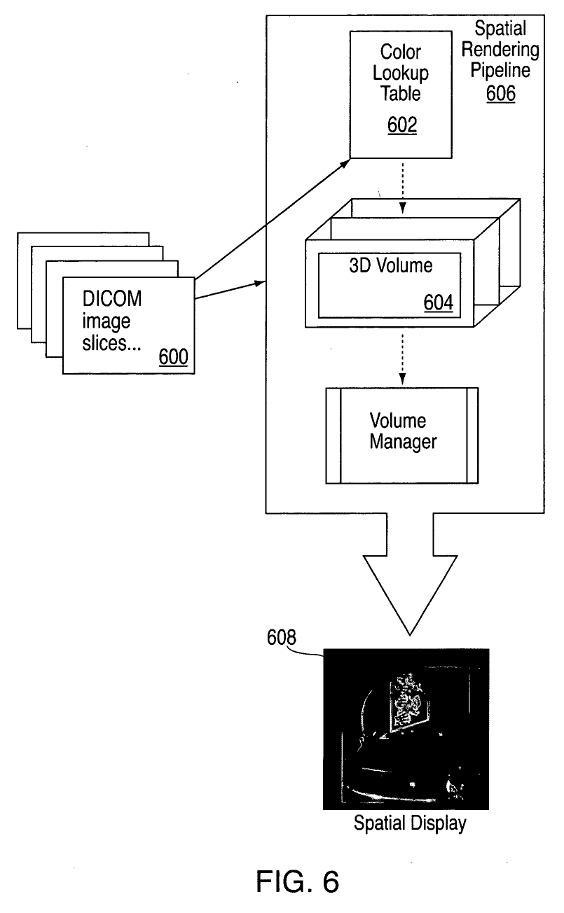

Referring initially to FIG. 6, there is shown a block diagram of a system for 3D volume construction from DICOM data, in accordance with an exemplary embodiment of the invention. Table 1 shows some exemplary psuedo code for a method in accordance with this exemplary embodiment. DICOM slices are loaded from files 600 on a storage medium into a memory buffer 604 as well as a color lookup table 602. The files 600, the memory buffer 604, and the color lookup table 602 stored on a storage medium and accessible to a computing device. This memory buffer 604 is part of a 3D volume rendering pipeline 606 such that the 3D volume is directly accessible to rendering hardware for uploading to a 3D display device 608, such as a spatial 3D display device. In an example embodiment, data is loaded from DICOM files 600 into a rectilinear grid in memory buffer 604 and, then, the data in the rectilinear grid is sampled and formatted into a cylindrical grid in memory 604 to be uploaded and displayed on the 3D display device 608. The rectilinear grid is loaded into a graphics card. The data is resliced by the graphics card to produce wedges and calculations are made of the intersections of the wedges with the original data set. The wedges are then formatted for 3D display by performing a color conversion by applying the color lookup table 602, in this exemplary embodiment.

TABLE 1
Psuedo Code

Browse for DICOM files

If DICOMDIR selected

Display all series determined to be 3D images

Read in selected DICOM files (or series)

Parse header files for volume parameters:

Dimensions and spacing in X, Y, Z
Pixel Format
Lookup table

Allocate 3D volume buffer using parsed parameters
For each file selected:

Read, parse and validate header
Collect color table data
Read and format pixels into voxel format and upload into volume
buffer

Generate and load color look up table to volume rendering pipeline.
Upload the 3D Volume buffer to rendering pipeline.

Another embodiment includes an application programming interface (API) or wrapper around a plug-in that provides (exports) a 3D volume data structure to another software application, in response to DICOM data input (import). Another embodiment is a standalone software package. Yet another embodiment is a software library including a browser that reads a DICOM set and a method that produces a pointer to volumetric data that is ready for display on a 3D display device 608. Still another embodiment is included as stored instructions on a storage device in a system together with a 3D display device 608. Still another embodiment is a system including the 3D display device 608 and software stored on a compact disk, read-only memory (CD-ROM) for producing 3D images for display on the device. A further embodiment is a software library that reads DICOM data and formats it for 3D display in memory, including generating one or more color lookup tables 602.

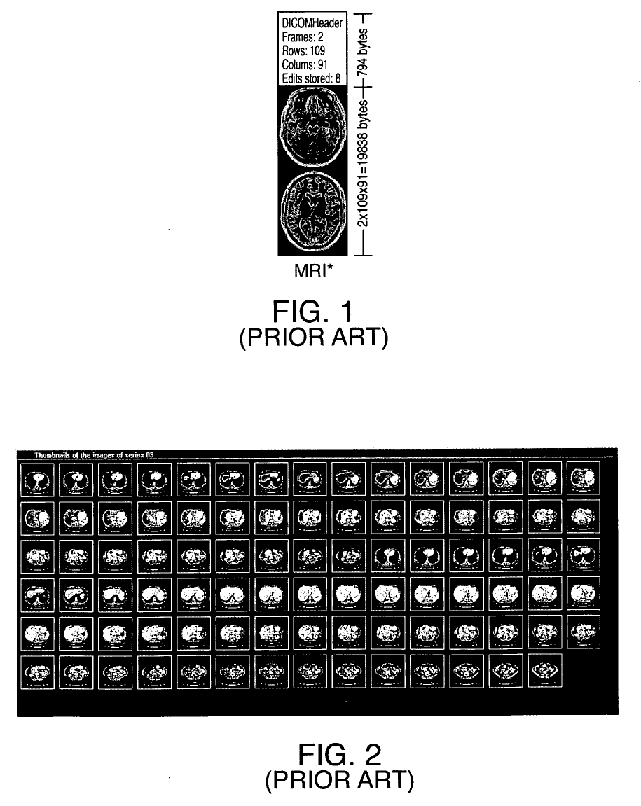

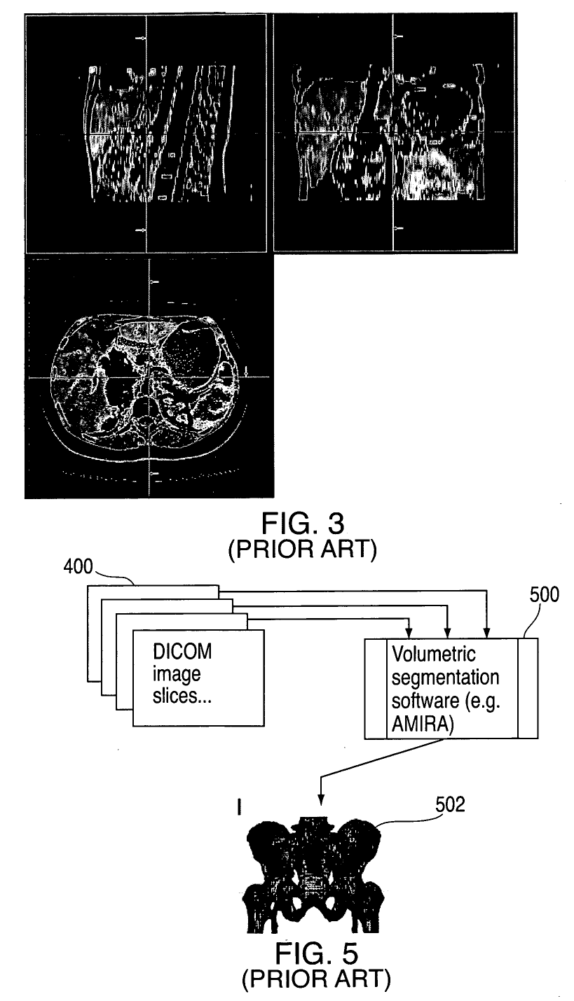

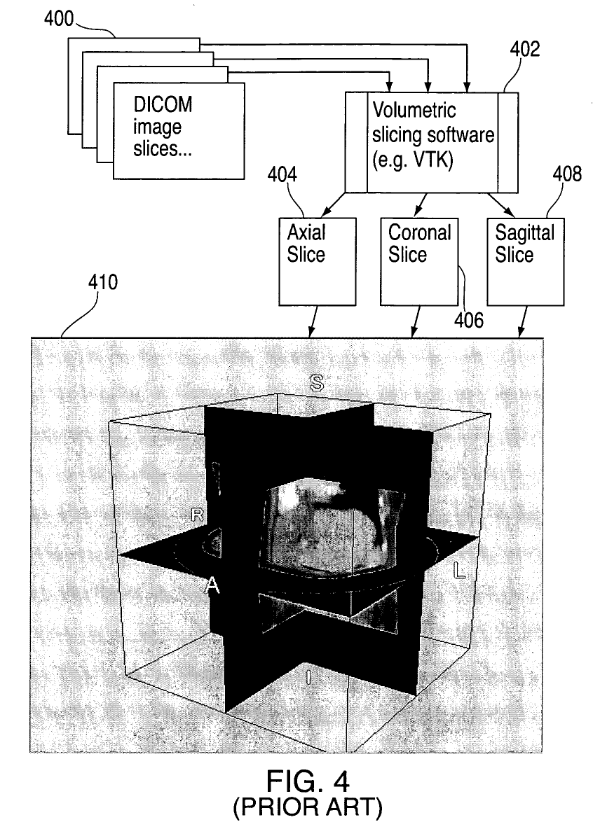

A lookup table is used by the system to hold and adjust the range of intensity values for each voxel in the 3D display in memory, including any thresholds. Intensity is information about color, amount of light and other display attributes. A voxel is a unit of graphic information that defines a point in three-dimensional space. The header 100 (FIG. 1) provides intensity information for image data. Suppose the image data has value 0-255 and a threshold of 100 is set, then data having a value less than 100 is not displayed. This is useful for isolating soft tissue or bone, for example. The range of values is determined over a 3D volume, not only a 2D slice, i.e. for each voxel.

An exemplary method of operating the system includes reading header 100 information from a DICOM file. Information in the header 100 includes patients, doctor information, time and date, diagnostics, device where the image data 102 was accumulated, device where the image was stored, and other information. The header is followed by bits of an image in one or more files or multiple images in multiple files. There are many different ways the image data 102 is specified and described following the header 100 according to the DICOM standard. The image data may be a 2D slice or an accumulation of slices that may be formed into a 3D image, taking into account the distances between them.

In an exemplary system, a graphical user interface (GUI), such as a browser is capable of interpreting DICOM file extensions and file formats, organizing DICOM data and presenting DICOM data by patient, study, series, and image. The browser distinguishes data sets suitable for output to a 3D display device 608 from other data sets, including 2D images. The browser allows selection of a complete 3D image, a contiguous subset of an image or other data sets for display. The slices are read in from one or more DICOM files. Information in the header is used to construct a 3D volume in memory. Information in the header about the 3D display's voxel format is used to convert pixel data to voxel data. If necessary, pixel data is offset and scaled to fit the output voxel format. A lookup table is generated to reflect DICOM window center, window width, window level, and threshold fields, among other information. The 3D display device 608 uses the lookup table to manipulate the contrast and intensity, without requiring that the pixel data be re-converted. If any DICOM data elements used in generating the volume are not specified, defaults specific to the 3D display or values determined from related data can be used. For example, if the slice location, slice thickness, or patient position are inconsistent, the system can either resolve it with a degree of confidence or query the user. Image data in memory is formatted and arranged for uploading directly to the 3D display device 608. An interface for volume dimensions and voxel size is provided.

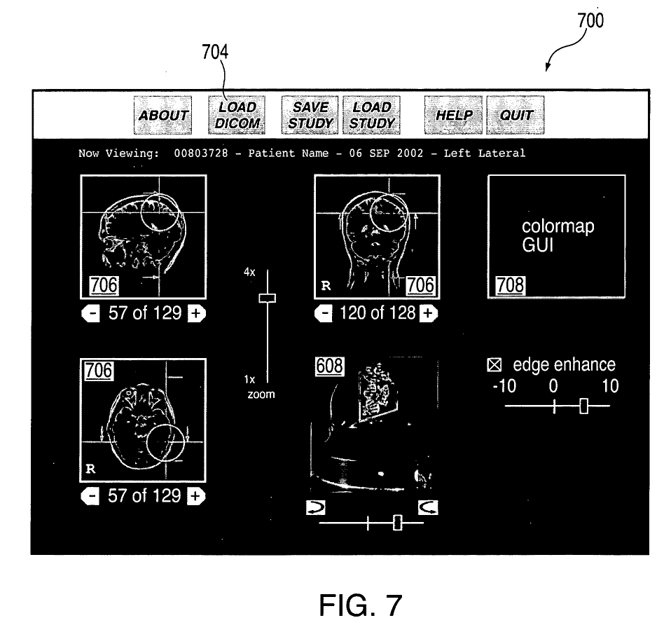

FIG. 7 shows an exemplary user interface 700, including a picture of a 3D display device 608. This exemplary user interface 700 is generated by an exemplary system. The system includes the 3D display device 702 and software that is stored as instructions on a storage medium. The 3D display device 702 provides 3D images and controls, such as rotate, zoom, and pan. The software runs in an operating system on a computing device, such as a personal computer (PC) that may be connected to a network. The software includes an exemplary method for constructing 3D volume data from DICOM data sets. DICOM data sets, such as imagery from CT, MR, and positron emission tomography (PET) is available on a hospital's network, such as the personal access communications system (PACS) and from portable storage devices, such as a CD-ROM. Some DICOM data sets include DICOM files having “.dcm” extensions, DICOM directories, “DICOMDIR”, and DICOM CDs.

The user interface 700 includes controls, such as load DICOM 704 among others. When a user selects to load DICOM 704, a file selector is provided for loading DICOM data sets. A DICOM reader may be used to locate and select a DICOM data set. The loading process may include loading files, parsing files, cleaning up files, and the like. Once loaded, 2D images 706 are provided in a number of views, such as sagital, coronal, and axial, according to medical conventions. Also, 3D images are provided on the 3D display device 608.

The load DICOM 704 process includes software that recognizes DICOM directories, files, and other DICOM data and finds sets of related files that relate to 3D images. The related files are selected and read in. For example, a whole set or a set of contiguous slices in a set may be selected. The header is consulted to determine the format of the image data. If necessary, image data can be reformatted. As each slice is read in, value ranges for each slice are accumulated, keeping a running minimum and maximum of the values. Intensity value ranges and thresholds are determined and assigned for each voxel of the volume by processing the data through a lookup table. Windowing parameters are determined to locate the volume on the 3D display device 608, such as in the center. User input may be used to adjust intensity and put thresholds on the extent of image data to be displayed. In one embodiment, a volume data set having an array of voxels is produced for display on a 3D display device 608.

The user interface 700 also includes a color map 708 and other image enhancement tools. The user can use the user interface 700 to adjust the zoom and pan of the 3D display device 608 and the user can adjust color, brightness, and intensity values of selected voxels in the 3D volume. For example, the user may choose to display certain ranges of values that correspond to bone, soft tissue, or lung tissue. The exemplary method receives the color map information and applies a lookup table to image data to produce the desired color adjustments.

In one use case, at a hospital a device accumulates image data 102 and stores it on a storage medium, such as a server. Then, a radiologist requests images for a list of patients from the server. The server sends the image data 102 back to the radiologist according to the DICOM standard. The exemplary method generates a 3D volume for display, from the image data 102 for each patient.

In another use case, a surgeon wants to take out a lung tumor. He has a hard time understanding if it is inside or outside the airway just by looking at 2D CAT scans. So, he asks the radiology technician to bring up the patient data on a 3D display device 608. The patient's torso appears. He asks the radiology technician to zoom in on the first major branching of the airway, saying “Show me the primary bronchi.” The technician can position the cursor in the 2D slices and use a zoom slider to zoom in on areas of interest. Various embodiments of the present invention provide volumetric data for such a 3D display.

In another use case, a cardiologist wants to treat a patient with an irregular heartbeat (an arrhythmia). Before the procedure, he asks the CAT/MR technician to bring up the patient's heart. He wants to see the raw CT data, thresholded for interesting regions, such as the left aorta and the left pulmonary artery. This allows him to see how to snake a catheter up the patient's leg and into a chamber of the heart. Various embodiments of the present invention provide volumetric data for such a 3D display.

While the invention has been described with reference to a preferred embodiment or embodiments, it will be understood by those skilled in the art that various changes may be made and equivalents may be substituted for elements thereof without departing from the scope of the invention. For example, in the future, the DICOM standard may be revised or updated and various embodiments of the present invention may be altered slightly to adjust to those changes, without going beyond the scope of the present invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1-18. (canceled)

19. A system for constructing 3D volumes from medical image data, comprising:
means for loading a data set into a memory of a computing device; and
means for constructing a 3D volume from said data set, said 3D volume being in a format for rendering at least a portion of said 3D volume to a 3D display device.

20. The system of claim 19, further comprising:
means for adjusting an intensity of at least one voxel in said 3D volume.

21. The system of claim 20, further comprising:
a user interface including an intensity and threshold selection in communication with said means for adjusting.

22. The system of claim 19, further comprising:
a user interface including a load selection for initiating said means for loading.

23. The system of claim 19, further comprising:
a 3D display device for displaying said 3D volume.

24. The system of claim 19, further comprising:
a browser for locating said medical image data set.

25. A method for constructing 3D volumes from medical image data comprising:
collecting image data in a medical image data set on a storage device;
forming said data into a 3D volume in a memory of a computing device;
displaying said 3D volume.

26. The method of claim 25 wherein said image data includes a plurality of slices

27. The method of claim 25, further comprising:
determining a range of intensity values for each voxel in said 3D volume;
receiving an adjustment of at least a portion of said intensity values; and
applying said adjustment to said 3D volume.

28. The method of claim 27, wherein said adjustment includes at least one threshold.

29. The method of claim 25, wherein said forming includes resolving missing data in said data set.

30. The method of claim 29, wherein resolving missing data includes receiving user input.

31. The method of claim 28, wherein resolving missing data includes providing defaults.

32. A storage medium, comprising:
machine-readable instructions for causing a computing machine to perform a method for constructing 3D volumes from medical image data, the method comprising:
collecting image data in a medical image data set on a storage device;
forming said data into a 3D volume in a memory of a computing device;
displaying said 3D volume.

33. The storage medium of claim 32 wherein the forming further includes:
converting pixels in a medical image data set to voxels;
determining an intensity value range for each voxel;
holding said intensity value ranges in a lookup table;
forming a 3D volume, said 3D volume having voxels; and
applying an intensity value to said 3D volume.

34. The storage medium of claim 32, further comprising:
loading said medical image data set.

35. The storage medium of claim 33, further comprising:
reformatting said medical image data set.

36. The storage medium of claim 32, further comprising:
receiving user input to adjust at least one value range of at least one voxel.

37. The storage medium of claim 34, further comprising:
adjusting said 3D volume according to said user input by applying said intensity value, without re-converting pixels to voxels.
